(19) United States
(12) Patent Application Publication
(10) Pub. No.: US 2013/0030790 A1
(43) Pub. Date: Jan. 31, 2013

(54) TRANSLATION APPARATUS AND METHOD USING MULTIPLE TRANSLATION ENGINES

(71) Applicants: Seong Il Yang, Daejeon (KR); Chang Hyun Kim, Daejeon (KR); Young Ae Seo, Daejeon (KR); Jong Hun Shin, Daejeon (KR); Jinxia Huang, Daejeon (KR); Young Kil Kim, Daejeon (KR); Sang Kyu Park, Daejeon (KR)

(72) Inventors: Seong Il Yang, Daejeon (KR); Chang Hyun Kim, Daejeon (KR); Young Ae Seo, Daejeon (KR); Jong Hun Shin, Daejeon (KR); Jinxia Huang, Daejeon (KR); Young Kil Kim, Daejeon (KR); Sang Kyu Park, Daejeon (KR)

(73) Assignee: ELECTRONICS AND TELECOMMUNICATIONS RESEARCH INSTITUTE, Daejeon (KR)

(21) Appl. No.: 13/560,151

(22) Filed: Jul. 27, 2012

(30) Foreign Application Priority Data
Jul. 29, 2011 (KR) 10-2011-0076035

(51) Int. Cl. G06F 17/28

(52) U.S. Cl. 704/2

(57) ABSTRACT

Disclosed is a translation apparatus and method using multiple translation engines. The translation apparatus using the multiple translation engines may include a structure analysis unit to analyze a structure of an original sentence, a sentence receiver to receive, from translation engines, translations of the original sentence, and a sentence determining unit to determine one of the received translations to be a translation result based on performance information for the translation engines corresponding to the structure of the original sentence.

### CROSS-REFERENCE TO RELATED APPLICATION

This application claims the benefit of Korean Patent Application No. 10-2011-0076035, filed on Jul. 29, 2011, in the Korean Intellectual Property Office, the disclosure of which is incorporated herein by reference.

### BACKGROUND

1. Field of the Invention

The present invention relates to a translation apparatus and method using multiple translation engines, and more particularly, to a translation apparatus and method for determining and storing a translation performance corresponding to a characteristic or a structure of a sentence for each translation engine, thereby estimating a translation rate of each translation translated based on an original sentence using a plurality of translation engines, and for selecting a translation based on a result of the estimation, thereby selecting a translation optimized to the original sentence among sentences translated by the plurality of translation engines.

2. Description of the Related Art

Translation engines may have a configuration for automatically translating a document in a language into in another language so as to generate another document in the other language. In this instance, a scheme of translating a language may vary depending on a characteristic of a sentence such as an expression scheme, a length, and the like of the sentence, and the same document may be translated differently depending on a translation engine used since each translation engine may be developed to be optimized to a characteristic of a sentence to be translated.

However, a document may include sentences having different characteristics, and a document mainly including sentences having one characteristic may include a portion of sentences having another characteristic. In this instance, when a translation engine optimized to one characteristic is used, a sentence having another characteristic may be mistranslated.

Thus, a scheme of enhancing a translation performance using multiple translation engines is being developed. A conventional scheme using multiple translation engines may include a scheme of selecting, as a translation result, a translation generated to be a sentence most similar to a form of an optimized object language among a plurality of translations generated by the multiple translation engines based on a value previously learned by an object language model, and a scheme of selecting, as a translation result, duplicate translations among a plurality of translations generated by the multiple translation engines.

However, a scheme using the object language model may exclude an object language from a translation, and a scheme of selecting duplicate translations may exclude duplicate translations depending on a translation engine.

Accordingly, there is a desire for a method of selecting a translation optimized to an original sentence among sentences translated by the multiple translation engines without being limited to a predetermined word or sentence, or whether translations are duplicated.

### SUMMARY

An aspect of the present invention provides an apparatus and method of estimating a translation rate of translating an original sentence translated by each translation engine of a plurality of translation engines by determining and storing, for each translation engine, a translation performance corresponding to a characteristic or a structure of a sentence.

Another aspect of the present invention also provides an apparatus and method of selecting a translation based on a result of estimating a translation rate, thereby selecting a translation optimized to an original sentence among sentences translated by the plurality of translation engines.

According to an aspect of the present invention, there is provided a translation apparatus, including a structure analysis unit to analyze a structure of an original sentence, a sentence receiver to receive, from the plurality of translation engines, translations of the original sentence, and a sentence determining unit to determine one of the received translations to be a translation result based on performance information for the translation engines corresponding to the structure of the original sentence.

According to another aspect of the present invention, there is provided an apparatus for generating performance information for the plurality of translation engines, the apparatus including a structure analysis unit to analyze a structure of a sample sentence, a sentence receiver to receive, from the plurality of translation engines, translations of the sample sentence, and a performance information generator to generate performance information for the translation engines based on the translations, an expected translation of the sample sentence, and the structure of the sample sentence.

According to still another aspect of the present invention, there is provided a translation method, including analyzing a structure of an original sentence, receiving, from the plurality of translation engines, translations of the original sentence, and determining one of the received translations to be a translation result based on performance information for the plurality of translation engines corresponding to the structure of the original sentence.

According to yet another aspect of the present invention, there is provided a method of generating performance information for the plurality of translation engines, the method including analyzing a structure of a sample sentence, receiving, from the plurality of translation engines, translations of the sample sentence, and generating performance information for the plurality of translation engines based on the translations, an expected translation of the sample sentence, and the structure of the sample sentence.

According to an embodiment of the present invention, it is possible to estimate a translation rate of translating an original sentence translated by each translation engine of the plurality of translation engines by determining and storing, for each translation engine of the plurality of translation engines, a translation performance corresponding to a characteristic or a structure of a sentence.

According to another embodiment of the present invention, it is possible to select a translation based on a result of estimating a translation rate, thereby selecting a translation optimized to an original sentence among sentences translated by the plurality of translation engines.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a translation apparatus using multiple translation engines according to embodiments of the present invention;

FIG. 2 is a diagram illustrating an example of a translation operation using multiple translation engines according to embodiments of the present invention;

FIG. 3 is a flowchart illustrating a method of generating performance information for translation engines according to embodiments of the present invention; and

FIG. 4 is a flowchart illustrating a translation method according to embodiments of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures. A translation method using multiple translation engines according to embodiments of the present invention may be performed by a translation apparatus using multiple translation engines.

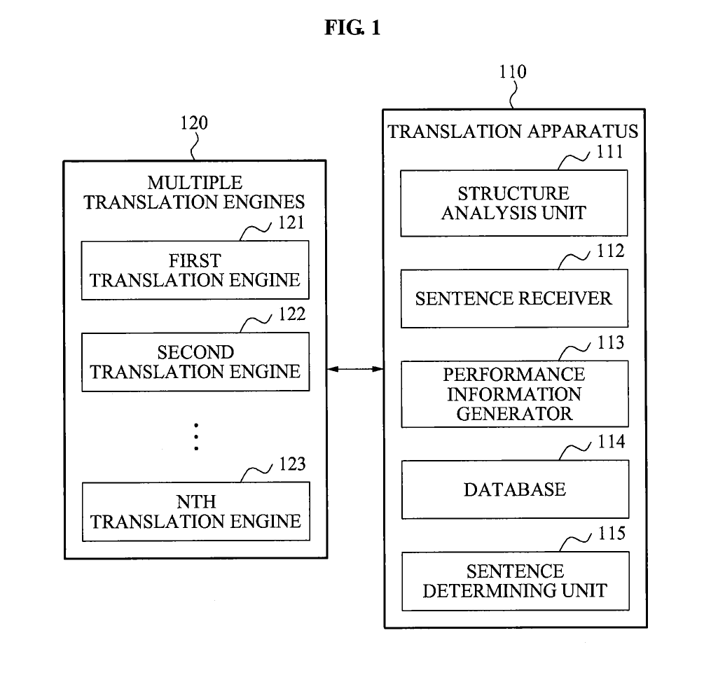

FIG. 1 is a block diagram illustrating a translation apparatus using multiple translation engines 120 according to embodiments of the present invention.

Referring to FIG. 1, a translation apparatus 110 using the multiple translation engines 120 according to embodiments of the present invention may include a structure analysis unit 111, a sentence receiver 112, a performance information generator 113, a database 114, and a sentence determining unit 115.

The translation apparatus 110 using the multiple translation engines 120 according to embodiments of the present invention may compare different translations generated by a plurality of unspecified translation engines having different characteristics that translate the same original sentence, and select the most exact translation among the translations, thereby enhancing a translation performance when compared to a single translation engine.

The structure analysis unit 111 may analyze a structure of an original sentence or a sample sentence. In this instance, the original sentence may refer to a sentence to be translated, and the sample sentence may refer to a sentence used for building a database by determining a performance of a single translation engine corresponding to a structure or a characteristic of a sentence.

In this instance, the structure analysis unit 111 may analyze the original sentence in units of morphemes, and extract a characteristic of the original sentence based on a type or a number of morphemes analyzed. A characteristic of a sentence may include information about a sentence form, a length, honorific structure, and a type of interrogative of the corresponding sentence. For example, when the original sentence corresponds to “ [symbol] [symbol] ?”, the sentence form may correspond to an interrogative sentence, the length may correspond to three phrases, the honorific structure may correspond to a general honorific structure, and the type of interrogative may indicate a position in the characteristic of the original sentence.

The sentence receiver 112 may receive, from the multiple translation engines 120, translations of the original sentence or the sample sentence. In particular, the sentence receiver 112 may transmit the original sentence or the sample sentence to the multiple translation engines 120 to request a translation, and receive translations from each translation engine among the multiple translation engines 120 in response to the request.

In this instance, the multiple translation engines 120 may include n translation engines of a first translation engine 121, a second translation engine 122 through an n^{th} translation engine 123. Here the n translation engines may translate a sentence received from the translation apparatus 110 and the translations may be collected and transmitted to the translation apparatus 110. That is, the multiple translation engines 120 may match information indicating a translation engine translating each of the collected translations.

Each translation engine included among the multiple translation engines 120 may translate the original sentence or the sample sentence using different pieces of translation information and thus, a translation rate may vary depending on a structure, a characteristic, and a field of a sentence. As an example, the first translation engine 121 may translate a sample sentence “AAA” to [A″AA], and the second translation engine 122 may translate the sample sentence “AAA” to [AA′A]. In this instance, the translation rate may correspond to a rate at which a translation is accurately completed by comparing an expected sentence to the translation.

The performance information generator 113 may generate performance information for the n translation engines based on a structure of the sample sentence, an expected sentence of the sample sentence, and translations generated by each of the n translation engines of the multiple translation engines 120 translating the sample sentence.

As an example, the performance information generator 113 may determine a translation performance of each translation engine among the multiple translation engines 120 by comparing the translations of the sample sentence to the expected sentence of the sample sentence, and generate performance information for the n translation engines by matching a result of the determination to the structure of the sample sentence. In this example, the performance information generator 113 may determine the translation performance of each translation engine among the multiple translation engines 120 based on a similarity between translations of the sample sentence and the expected sentence of the sample sentence, and match a result of the determination to the structure of the sample sentence, thereby generating the performance information for the n translation engines corresponding to the structure of the sample sentence. In this instance, the expected sentence may correspond to a translation of the sample sentence translated by a user. Accordingly, the translation performance of the n translation engines may include the translation rate of the translation translated by the n translation engines.

As another example, the performance information generator 113 may determine the translation performance of each translation engine among the multiple translation engines 120 corresponding to a characteristic of a sentence based on the translations of the sample sentence and the expected sentence of the sample sentence, and generate performance information for the n translation engines by matching a result of the determination to the characteristic of the sentence. In particular, the performance information generator 113 may determine the translation performance of each translation engine among the multiple translation engines 120 corresponding to a characteristic of the sample sentence based on a similarity between translations of the sample sentence and the expected sentence of the sample sentence.

As still another example, the performance information generator 113 may estimate the translation performance of each translation engine among the multiple translation engines 120 for each characteristic by compiling statistics of the translation performance of each translation engine among the multiple translation engines 120 for each characteristic, and weight each translation engine among the multiple translation engines 120 for each characteristic based on a result of the estimation. In this instance, the performance information for the n translation engines may correspond to a weighting set to each translation engine among the multiple translation engines 120, for each characteristic.

The database 114 may store the performance information for the n translation engines generated by the performance information generator 113. The database 114 may further store information about a probability value of an object language model.

The sentence determining unit 115 may determine one of the received translations to be a translation result based on the performance information for the n translation engines stored in the database 114.

In this instance, the sentence determining unit 115 may search for a structure of the sample sentence most similar to the structure of the original sentence in the performance information for the n translation engines, and determine one of the received translations to be a translation result based on a translation performance of each of the n translation engines matching the found sample sentence.

For example, when a translation rate of the first translation engine 121 corresponds to 0.7, and a translation rate of the second translation engine 122 corresponds to 0.9 for a fifth sentence pattern in English, when the original sentence corresponds to the fifth sentence pattern, the sentence determining unit 115 may determine a translation generated by the second translation engine 122 to be a translation result. Further, when a translation rate of the first translation engine 121 corresponds to 0.9, and a translation rate of the second translation engine 122 corresponds to 0.5 for a fourth sentence pattern in English, when the original sentence corresponds to the fourth sentence pattern, the sentence determining unit 115 may determine a translation generated by the first translation engine 121 to be a translation result.

The sentence determining unit 115 may determine one of the received translations to be a translation result based on a translation performance of each translation engine among the multiple translation engines 120 matching a characteristic of the original sentence in the performance information for the n translation engines.

In particular, the sentence determining unit 115 may estimate a translation rate of a translation by selecting at least one among weightings for each characteristic of each translation engine among the multiple translation engines 120 corresponding to the original sentence analyzed by the structure analysis unit 111. For example, when a weighting of the first translation engine 121 corresponds to 0.32 for an interrogative sentence, 0.52 for an imperative sentence, 0.9 for a sentence excluding an honorific structure, 0.8, for a sentence including an honorific structure and the original sentence corresponds to an imperative sentence excluding an honorific structure, the sentence determining unit 115 may estimate a translation rate of a translation generated by the first translation engine 121 based on the 0.52 weighting for an imperative sentence and the 0.9 weighting for a sentence excluding an honorific structure. In this instance, the sentence determining unit 115 may determine a sentence having a greatest translation rate to be a translation result.

According to embodiments of the present invention, a translation performance corresponding to a characteristic or a structure of a sentence may be determined and stored for each translation engine among the multiple translation engines 120 and thus, a translation rate of a translation corresponding to the original sentence may be estimated, and a translation having a greatest translation rate may be selected.

That is, a translation engine optimized to a structure or a characteristic of the original sentence desired to be translated may be estimated, and a translation translated by the estimated translation engine may be selected and thus, a translation optimized to the original sentence may be selected from translations translated by of the multiple translation engines 120.

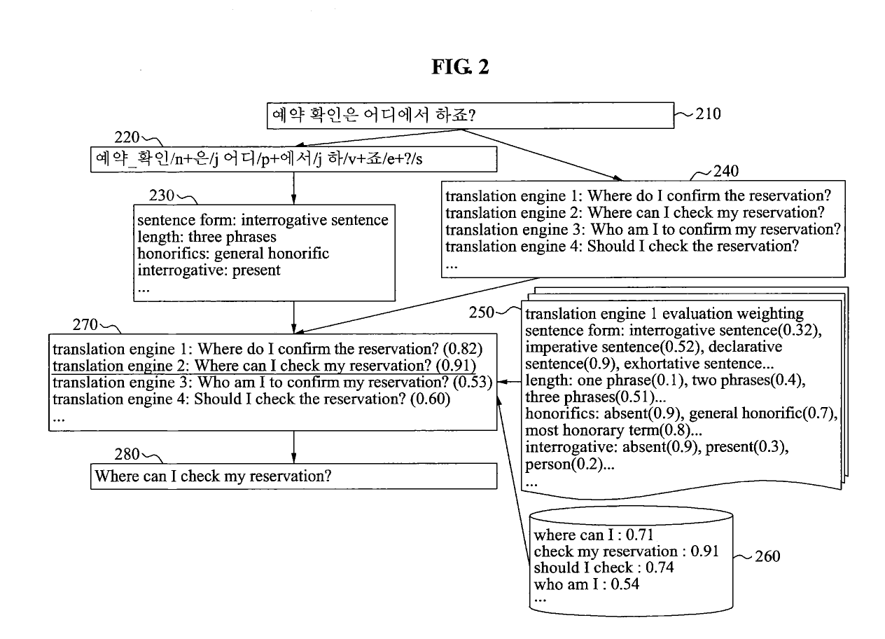

FIG. 2 is a diagram illustrating an example of a translation operation using the multiple translation engines 120 according to embodiments of the present invention.

Referring to FIG. 2, in response to an input of an original sentence 210 being received, the structure analysis unit 111 of FIG. 1 may analyze the original sentence 210 in units of morphemes such as a noun n, a postposition j, a pronoun p, a predicate v, an ending e. In this instance, the structure analysis unit 111 may extract a characteristic 230 of the original sentence based on a number of morphemes or a type of morpheme included in a result of the analysis 220 in units of morphemes. For example, the structure analysis unit 111 may extract the characteristic 230 of the original sentence in which a sentence form corresponds to an interrogative sentence, a length corresponds to three phrases, an honorific structure corresponds to a general honorific structure, and a type interrogative indicating a position.

In this instance, the sentence receiver 112 of FIG. 1 may transmit the original sentence 210 to the multiple translation engines 120 of FIG. 1, and receive, from the multiple translation engines 120, translations 240 of the original sentence 210 translated by each translation engine.

The sentence determining unit 115 of FIG. 1 may extract, from the database of FIG. 114, a weighting 250 for each characteristic of each translation engine among the multiple translation engines 120. The sentence determining unit 115 may extract, from the database 114, information about a probability value of an object language model 260 corresponding to a structure of the original sentence 210.

The sentence determining unit 115 may estimate a translation rate 270 of a translation based on the weighting 250 for each characteristic of each translation engine among the multiple translation engines 120 and the probability value of an object language model 260. In particular, the sentence determining unit 115 may estimate the translation rate 270 of a translation based on a value corresponding to the characteristic 230 of the original sentence in the weighting 250 for each characteristic of each translation engine among the multiple translation engines 120 and a probability of a sentence included in the translation in the probability value of an object language model 260.

The sentence determining unit 115 may determine a translation having a greatest translation rate to be a translation result 280, thereby determining a translation optimized to the original sentence 210 to be the translation result 280.

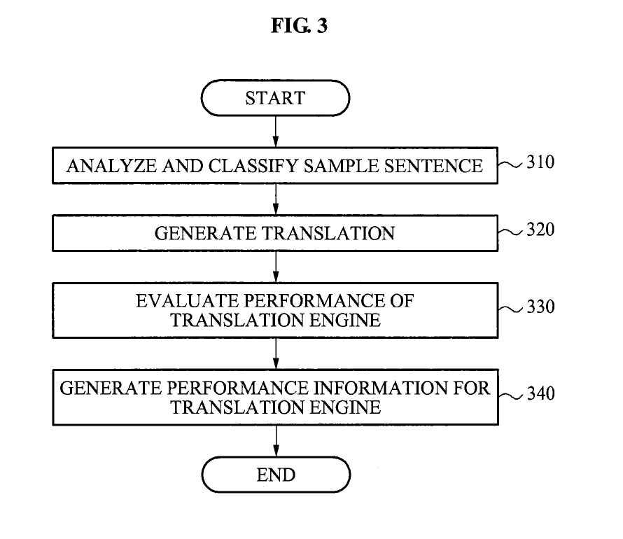

FIG. 3 is a flowchart illustrating a method of generating performance information for translation engines according to embodiments of the present invention.

In operation 310, the structure analysis unit 111 of FIG. 1 may analyze a structure of a sample sentence. In this instance, the structure analysis unit 111 may analyze the sample sentence in units of morphemes, and extract a characteristic of the sample sentence based on a type or a number of morphemes analyzed. The structure analysis unit 111 may classify types of the sample sentence based on the structure or the characteristic of the sample sentence.

In operation 320, the sentence receiver 112 of FIG. 1 may transmit the sample sentence to the multiple translation engines 120 of FIG. 1 to request translation of the sample sentence, and the multiple translation engines 120 may translate the sample sentence in each translation engine among the multiple translation engines 120 to generate translations in response to the request. In this instance, the sentence receiver 112 may receive the translations generated by the multiple translation engines 120.

In operation 330, the performance information generator 113 may evaluate a performance of each translation engine among the multiple translation engines 120 based on the translation generated in operation 320, an expected translation of the sample sentence, and a structure of the sample sentence. In this instance, the performance information generator 113 may evaluate the performance of each translation engine among the multiple translation engines 120 by comparing the translations generated by translating the sample sentence to the expected translation of the sample sentence.

In operation 340, the performance information generator 113 may generate evaluation information for each translation engine among the multiple translation engines 120 based on a result of the evaluation in operation 330, and store the evaluation information in the database of FIG. 1.

As an example, the performance information generator 113 may determine a translation performance of each translation engine among the multiple translation engines 120 based on a similarity between translations of the sample sentence and the expected translation of the sample sentence, and match a result of the determination to the structure of the sample sentence analyzed in operation 310, thereby generating the performance information for each translation engine among the multiple translation engines 120 corresponding to the structure of the sample sentence.

As another example, the performance information generator 113 may determine a translation performance of each translation engine among the multiple translation engines 120 corresponding to the characteristic of the sample sentence analyzed in operation 310 based on a similarity between the translations of the sample sentence and the expected sentence of the sample sentence. In this instance, the performance information generator 113 may estimate the translation performance of each translation engine among the multiple translation engines 120 for each characteristic by compiling statistics of the translation performance of each translation engine among the multiple translation engines 120 for each characteristic, and weight each translation engine among the multiple translation engines 120 for each characteristic based on a result of the estimation. In this instance, the performance information for each translation engine among the multiple translation engines 120 may correspond to a weighting set to each translation engine among the multiple translation engines 120, for each characteristic.

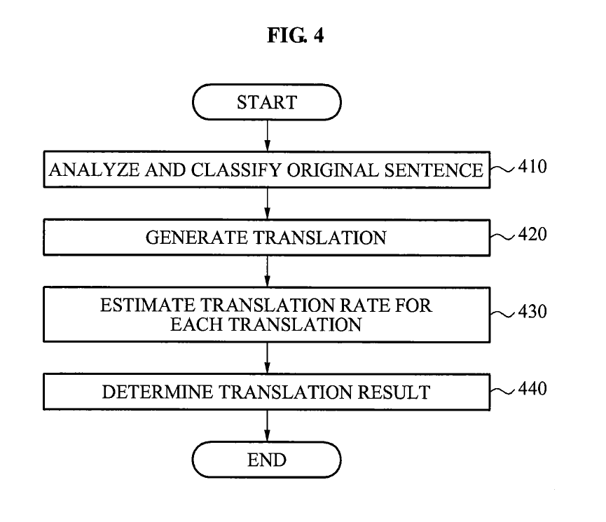

FIG. 4 is a flowchart illustrating a translation method according to embodiments of the present invention.

In operation 410, the structure analysis unit 111 of FIG. 1 may analyze a structure of an original sentence. In this instance, the structure analysis unit 111 may analyze the original sentence in units of morphemes, and extract a characteristic of the original sentence based on a type or a number of morphemes analyzed. The structure analysis unit 111 may classify types of the original sentence based on the structure or the characteristic of the original sentence.

In operation 420, the sentence receiver 112 of FIG. 1 may transmit the original sentence to the multiple translation engines 120 of FIG. 1 to request a translation, and the multiple translation engines 120 may translate the original sentence in each translation engine among the multiple translation engines 120 to generate translations in response to the request. In this instance, the sentence receiver 112 may receive the translations generated by the multiple translation engines 120. In operation 430, the sentence determining unit 115 of FIG. 1 may estimate a translation rate of translations generated in operation 420 based on performance information stored in the database 114 of FIG. 1 for each translation engine among the multiple translation engines 120. In this instance, the sentence determining unit 115 may search for a structure of a sample sentence most similar to the structure of the original sentence analyzed in operation 410 in the performance information for each translation engine among the multiple translation engines 120, and estimate a translation rate of each translation engine among the multiple translation engines 120 matching a found sample sentence to be a translation rate of the translations. The sentence determining unit 115 may estimate a translation rate of the translations generated in operation 420 by selecting at least one among weightings for each characteristic of each translation engine among the multiple translation engines 120 corresponding to the characteristic of the original sentence analyzed in operation 410.

In operation 440, the sentence determining unit 115 may determine one of the translations generated in operation 420 to be a translation result based on the translation rate of the translations estimated in operation 430. For example, the sentence determining unit 115 may determine a translation having a greatest translation rate among the translations estimated in operation 430 to be a translation result.

According to exemplary embodiments of the present invention, a performance of each translation engine among the multiple translation engines 120 corresponding to a characteristic of a sentence may be measured, and a result of the measurement may be stored and thus, a translation rate of a translation translated by each of a plurality of translation engines translating an original sentence.

By selecting a translation based on a result of estimating a translation rate, a translation optimized to an original sentence may be selected among translations translated by a plurality of transmission engines. In particular, by a weighting corresponding to a result of estimation on a translation, a translation of a translation engine optimized for translating a sentence having the same characteristic or structure as the original sentence may be selected as a translation result.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A translation apparatus, comprising:
a structure analysis unit to analyze a structure of an original sentence;
a sentence receiver to receive, from a plurality of translation engines, translations of the original sentence; and
a sentence determining unit to determine one of the received translations to be a translation result based on performance information for the plurality of translation engines corresponding to the structure of the original sentence.

2. The translation apparatus of claim 1, further comprising:
a performance information generator to generate the performance information for the plurality of translation engines based on a structure of a sample sentence, an expected translation of the sample sentence, and translations generated by each of the plurality of translation engines translating the sample sentence.

3. The translation apparatus of claim 2, wherein the performance information generator determines a translation performance of each of the plurality of translation engines by comparing the translations generated by translating the sample sentence to the expected translation of the sample sentence, and generates performance information for the plurality of translation engines by matching a result of the determination to the structure of the sample sentence.

4. The translation apparatus of claim 2, wherein the sentence determining unit searches for a structure of a sample sentence most similar to the structure of the original sentence in the performance information for the plurality of translation engines, and determines one of the received translations to be a translation result based on a translation performance of each of the plurality of translation engines matching the found sample sentence.

5. The translation apparatus of claim 2, wherein the structure analysis unit analyzes the original sentence in units of morphemes, and extracts a characteristic of the original sentence based on a type or a number of morphemes analyzed.

6. The translation apparatus of claim 5, wherein the performance information generator determines the translation performance of each of the plurality of translation engines corresponding to a characteristic of a sentence based on the expected translation of the sample sentence and the translations generated by translating the sample sentence, and generates the performance information for the translation plurality of engines by matching a result of the determination to the characteristic of the sentence.

7. The translation apparatus of claim 5, wherein the sentence determining unit determines one of the received translations to be a translation result based on the translation performance of each of the plurality of translation engines matching the characteristic of the original sentence in the performance information for the plurality of translation engines.

8. An apparatus for generating performance information for a plurality of translation engines, the apparatus comprising:
a structure analysis unit to analyze a structure of a sample sentence;
a sentence receiver to receive, from the plurality of translation engines, translations of the sample sentence; and
a performance information generator to generate performance information for the plurality of translation engines based on the translations, an expected translation of the sample sentence, and the structure of the sample sentence.

9. The apparatus of claim 8, wherein the performance information generator determines a translation performance of each of the plurality of translation engines by comparing the translations to the expected translation of the sample sentence, and generates the performance information for the plurality of translation engines by matching a result of the determination to the structure of the sample sentence.

10. The apparatus of claim 8, wherein the structure analysis unit analyzes an original sentence in units of morphemes, and extracts a characteristic of the original sentence based on a type or a number of morphemes analyzed.

11. The apparatus of claim 10, wherein the performance information generator determines a translation performance of each of the plurality of translation engines corresponding to a characteristic of a sentence based on the translations and the expected sentence of the sample sentence, and generates the performance information for the plurality of translation engines by matching a result of the determination to the characteristic of the sentence.

12. A translation method, comprising:
analyzing a structure of an original sentence;
receiving, from a plurality of translation engines, translations of the original sentence; and
determining one of the received translations to be a translation result based on performance information for the plurality of translation engines corresponding to the structure of the original sentence.

13. The translation method of claim 12, further comprising:
generating the performance information for the plurality of translation engines based on a structure of a sample sentence, an expected translation of the sample sentence, and translations generated by each of the plurality of translation engines translating the sample sentence.

14. The translation method of claim 13, wherein the generating comprises:
determining a translation performance of each of the plurality of translation engines by comparing the translations generated by translating the sample sentence to the expected translation of the sample sentence; and
generating performance information for the plurality of translation engines by matching a result of the determination to the structure of the sample sentence.

15. The translation method of claim 13, wherein the determining comprises:
searching for a structure of a sample sentence most similar to the structure of the original sentence in the performance information for the plurality of translation engines; and
determining one of the received translations to be a translation result based on a translation performance of each of the plurality of translation engines matching the found sample sentence.

16. The translation method of claim 13, wherein the analyzing comprises:
analyzing the original sentence in units of morphemes; and
extracting a characteristic of the original sentence based on a type or a number of morphemes analyzed.

17. The translation method of claim 16, wherein the generating comprises:
determining a translation performance of each of the plurality of translation engines corresponding to a characteristic of a sentence based on the expected translation of the sample sentence and the translations generated by translating the sample sentence; and
generating the performance information for the plurality of translation engines by matching a result of the determination to the characteristic of the sentence.

18. The translation method of claim 16, wherein the determining comprises:
searching for a translation performance of each of the plurality of translation engines matching the characteristic of the original sentence; and
determining one of the received translations to be the translation result based on a result of the search.

19. A method of generating performance information for a plurality of translation engines, the method comprising:
analyzing a structure of a sample sentence;
receiving, from the plurality of translation engines, translations of the sample sentence; and
generating performance information for the plurality of translation engines based on the translations, an expected translation of the sample sentence, and the structure of the sample sentence.
